(19) United States
(12) Patent Application Publication
(10) Pub. No.: US 2015/0145728 A1
(43) Pub. Date: May 28, 2015

(54) HIGH FREQUENCY TRANSMITTER AND RECEIVER TRACKING SYSTEM

(71) Applicant: Michael Jonathan Addison, Sugar Creek, MO (US)

(72) Inventor: Michael Jonathan Addison, Sugar Creek, MO (US)

(21) Appl. No.: 14/087,071

(22) Filed: Nov. 22, 2013

(51) Int. Cl. G01S 5/02

(52) U.S. Cl. CPC G01S 5/0294
USPC 342/465

(57) ABSTRACT

A tracking system for remotely tracking the movement and location of an object in a three-dimensional space. The tracking system including a transmitter for transmitting a signal, a plurality of receivers for receiving the signal, and a computing device for determining a location of the object based on known positions of the receivers and a time difference between the time that the signal is transmitted and the time that the receivers receive the signal.

### BACKGROUND

1. Field of Invention

Embodiments of the present invention generally relate to tracking systems for remotely monitoring the movement of one or more objects and/or points on an object in indoor and outdoor environments. More particularly, the present invention relates to a high frequency transmitter and receiver tracking system that identifies and tracks one or more objects and/or points on an object or objects as it moves through three-dimensional space in indoor and outdoor environments with improved speed and accuracy.

2. Related Art

Conventional indoor tracking systems are used to determine the movement of an object or person in an indoor environment. However, because these tracking systems vary considerably in terms of accuracy, size, complexity, cost, and ease of use, many of these indoor systems have shortcomings. For example, global positioning systems (GPS) have difficulty quickly and accurately determining horizontal indoor movements of an object due to the attenuating effect of the exterior shell effect of the building on the carrier signals. The inaccuracy of magnetic compass systems can also be very pronounced due to interference that structural materials may have on the compass. Inertial navigation systems, stereoscopic tracking methods used in cinema, and optical motion capture systems can be used indoors to track the movement of an object, but they are bulky, unwieldy, prohibitively expensive, and require many hours to set-up and operate. Moreover, optical motion capture systems are limited to line-of-sight operation in a single confined space; require a carefully controlled lighting environment; and are large and require intrusive components to be attached to the object being tracked. Real-time locating systems (RTLS) can also be used indoors to track the location of an object or a person. A RTLS, however, must be within the line-of-sight of the receiver to function.

Likewise, conventional outdoor tracking systems are used to locate and monitor an object's movement in an outdoor environment. However, these outdoor tracking systems are too slow to accurately track minute movements. For example, conventional wireless local area networks (LAN) and GPS must continuously perform the operations of scanning, analyzing, and interpreting tracking data before the gross movement and location of an object in two-dimensional space can be determined. Accordingly, these outdoor tracking systems have a lag time that makes them impractical for rapidly identifying and tracking minute three-dimensional movements of one or more objects and/or several points on an object. In addition, the ionosphere can interfere with and create unpredictable delays of GPS tracking signals, making them unreliable and inaccurate.

Hence, an improved tracking system that overcomes the above limitations is needed.

### SUMMARY

An improved three-dimensional tracking system that overcomes the above limitations is provided. More particularly, a transmitter and receiver tracking system that can be used indoors and outdoors to easily, quickly, inexpensively, and accurately identify and track three-dimensional movements of an object or objects and/or points on an object or objects is provided.

The present invention can be used to accurately track the gross body movements of one or more individuals; fine body movements of one or more individuals; the movement of specific body parts (head, hands, feet, etc.); as well as the movements of sport equipment used by athletes such as helmets, footballs, basketballs, bats, baseballs, golf clubs, hockey pucks, etc. in both indoor and outdoor environments; prosthetics used in rehabilitation facilities; mobile equipment; safety devices, e.g., a crash test dummy; or any other movable object. Tracking athlete movements can be used for player improvement or for correcting faulty sport mechanics. The present invention can be used to determine if a ball has crossed a goal line, a first down line, a sideline, or other boundary, or passed through a strike zone, for example. The invention can also be used to alert a referee to an offside violation, to pinpoint a correct placement of a football after a play, or to analyze team formations and player routes.

The present invention broadly includes at least one transmitter and at least three receivers for tracking three-dimensional movement of one or more objects and/or points on one or more objects. The small, light-weight transmitter generates a signal at least every 1/10th of a second with a signal frequency that is at least 433 MHz. Each receiver has an antenna that receives each transmitter's signal. The receiver or a computing device identifies each transmitter and calculates the signal's time delay from the time of transmission to the time of reception. The computing device uses the signals to accurately determine the transmitter(s)'s relative position in space by using one or more algorithms such as trilateration or triangulation.

With a transmitter's known position in time, the computing device can also calculate a distance travelled and therefore can calculate the transmitter's speed. Using the transmitter's calculated speed and physical characteristics of the tracked object, the computing device can calculate additional values including but not limited to inertia, g-forces, pressure, reaction time, and velocity. This summary is provided to introduce a selection of concepts in a simplified form that are further described in the detailed description below. The summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a receiver and transmitter tracking system for remotely tracking the three-dimensional gross movement of a person, in accordance with an embodiment of the present invention;

FIG. 2 is an elevation view of a person donning multiple transmitters for identifying and tracking the minute three-dimensional movements of his various body parts, in accordance with an embodiment of the present invention;

FIG. 3 is a perspective view of a receiver and transmitter tracking system for simultaneously identifying and tracking the gross three-dimensional movements of several individuals, minute three-dimensional movements of one individual, and the location and movement of a ball, according to one embodiment of the present invention; and

FIG. 4 is a block diagram of the receiver and transmitter tracking system of FIG. 1, according to one embodiment of the present invention.

The drawing figures do not limit the current invention to the specific embodiments disclosed and described herein. The drawings are not necessarily to scale, emphasis instead being placed upon clearly illustrating the principles of the present invention.

### DETAILED DESCRIPTION OF THE EMBODIMENTS

The following detailed description of the present invention references the accompanying drawings that illustrate specific embodiments in which the present invention can be practiced. The embodiments are intended to describe aspects of the present invention in sufficient detail to enable those skilled in the art to practice the present invention. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

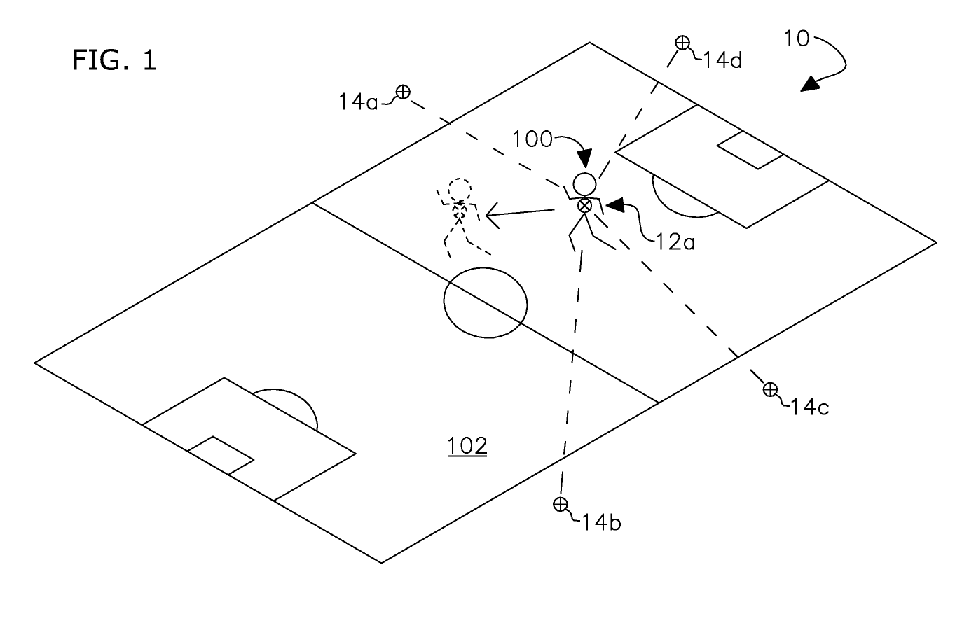

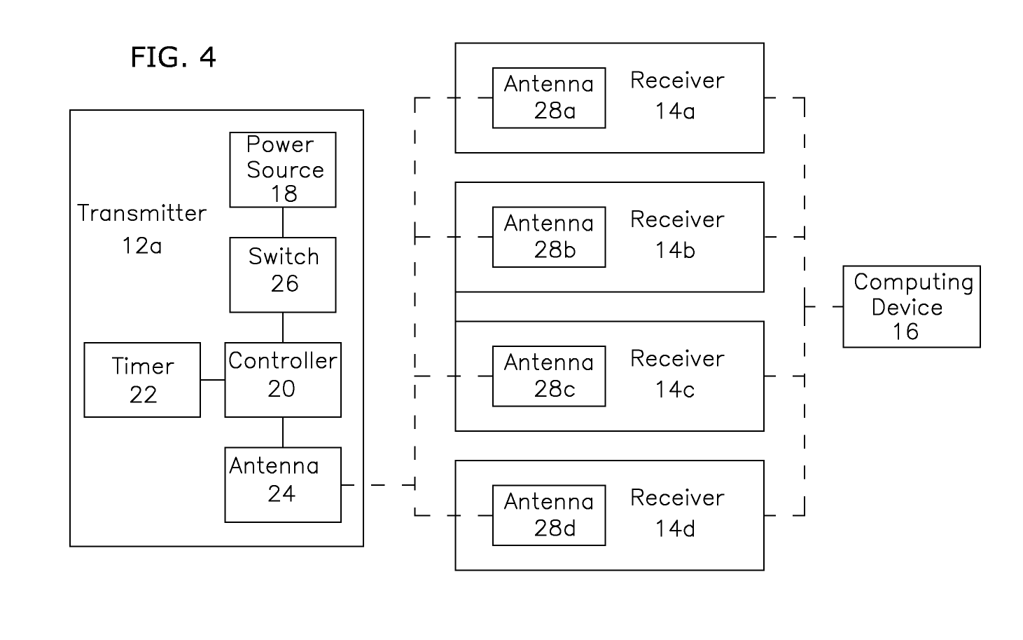

Turning now to the drawing figures, and particularly FIGS. 1-4, the tracking system 10 remotely tracks the movement of an object (e.g., player 100) in a three-dimensional space (e.g., the space above soccer field 102). Further examples of objects that can be tracked by the tracking system 10 include, but are not limited to, live animals, sports equipment, vehicles, and airplanes, or any other movable object. In a simple form, and as shown in FIG. 1, the tracking system 10 includes a transmitter 12a located on the player 100 for transmitting a signal, multiple receivers 14a-d for receiving the signal, and a computing device 16 (FIG. 4) for calculating the location, distance moved, speed, and other information of the object as described further below. Additional transmitters 12b-g may be used as described below. However, because they are essentially identical to transmitter 12a, only transmitter 12a will be described in detail.

The transmitter 12a is flexible, small, and light-weight, generally weighing less than five grams. The transmitter 12a may be quickly adhered to the player 100 or other object and also is easily removed therefrom. Various adhesives or materials can be used to attach the transmitter to the player 100, including but not limited to, adhesives, tape, mastic, paste, glue, and/or Velcro®. The adhesive may be temporarily protected by a removable cover, e.g., a thin plastic or cloth strip. The transmitter 12a can be disposed of after use.

The transmitter 12a also includes the following: 1) a power source 18 capable of generating power for at least five hours; 2) a controller 20 with an internal timer 22 for triggering a signal at a very precise interval; 3) an antenna 24 for transmitting the signal; and 4) a unique identifier for distinguishing it from additional transmitters 12b-f, described below. The power source 18 can be a small battery, e.g., a lithium cell, silver oxide cell, zinc air cell, button alkaline cell, or any other similar type of power source 18 that may or may not be rechargeable by plugging into an electrical outlet or by charging wirelessly. The internal timer 22 can be a crystal oscillator, e.g., a quartz crystal, or other timer capable of precisely triggering a signal at least every 1/10^{th} of a second. The transmitter 12a may be on different frequencies, may share the same frequency as other transmitters, or may hop from one frequency to another, (e.g., spread-spectrum frequency hopping). The unique identifier may be a serial or alpha numerical number or other identifier for distinguishing each transmitter 12a. The identifier may be a bar code, a quick-response (QR) code, a printed number, a radio-frequency identification number, or any other type of numerical identifier that can be scanned by a wireless computing device or read by a person.

The transmitter 12a may be activated by moving a switch 26 located on the transmitter 12a; scanning the bar code; removing a physical obstruction, such as a thin plastic strip, from its internal circuit; or removing its protective adhesive cover. Visual, audio, or other feedback can be included to verify that the transmitter 12a is active and transmitting. The transmitter 12a generates a signal at least every 1/10^{th} of a second. The signal's frequency is at least 433 MHz. The signal may include the unique identifier for being identified by the receivers 14a-d and/or the computing device 16 and a sequential identifier for identifying when the signal was transmitted. The sequential identifier is incremented from the sequential identifier of the previous signal. The sequential identifiers may be reset after reaching a pre-determined value.

Each receiver 14a-d has an antenna 28a-d or signal-receptive feature, respectively, for sensing the signal from the transmitter 12a. The receivers 14a-d are placed around the three-dimensional environment for triangulating or trilaterating the signals from the transmitter 12a. Each receiver 14a-d identifies the transmitter 12a via the unique identifier in the signal and communicates to the computing device 16 the exact time the transmitter 12a transmitted the signal and the exact time that it received the signal via a wired, wireless, or any other standard data transmission process. Each receiver 14a-d also communicates with the computing device 16 for calibration prior to use.

Although four receivers 14a-d are depicted in FIG. 1, the tracking system 10 can operate with a minimum of three receivers 14a-c located within range of the transmitter 12 signal. It is known by those skilled in the art that all known wireless systems have an acceptable level of error caused by the penetrating mass, i.e., walls, furniture, etc., which may decelerate, reflect, or refract the signal. The tracking system 10 may account for errors by utilizing redundant receivers for eliminating erroneous data points.

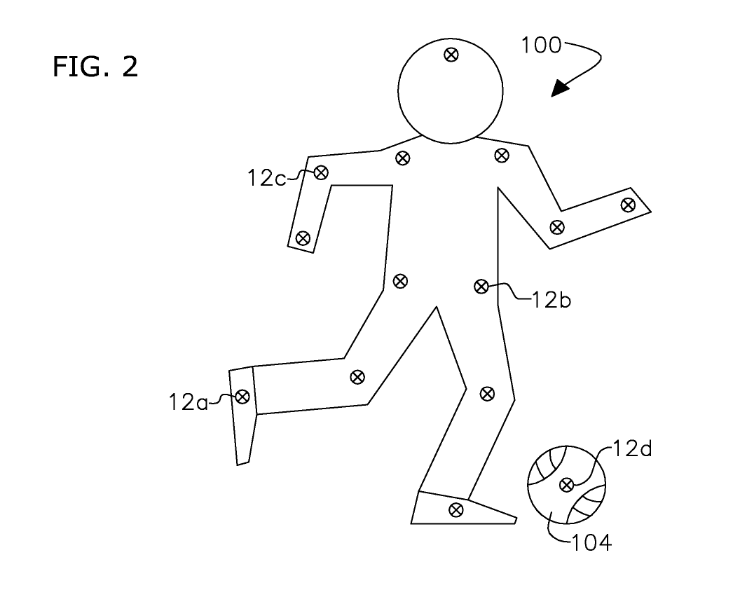

The computing device 16 receives the location and movement data in the signals collected by each receiver 14a-d and uses software to instantly process, analyze, and/or store the data for later use. For example, and as shown in FIG. 2, a signal generated by the transmitter 12a located on the foot of the player 100 could be analyzed by software in real time during the soccer game to determine the foot's velocity when it contacted the soccer ball 104. Alternatively, stored data may later be compared to the location and movement data of the same or different player or object for evaluation. Such an analysis may be advantageous in identifying areas for player improvement or for selecting players for a team.

The computing device 16 calculates the precise distance the transmitter 12a moves and determines a relative position of the transmitter 12a in the three-dimensional space using one or more locating algorithms, such as trilateration or triangulation. Accordingly, the computing device 16 can quickly and accurately determine the exact location of the player 100 by determining the player's gross movements in any direction in the three-dimensional space at least every 1/10^{th} of a second.

The computing device 16 may include or may be configured to access one or more computer programs stored in or on computer-readable medium. The computer programs may comprise listings of executable instructions for implementing logical functions in the computers and can be embodied in any non-transitory computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can contain, store, or communicate the programs. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

To calibrate the tracking system 10, a transmitter 12a is placed in a first known location. The receivers 14a-d receives a signal from the transmitter 12a and communicates the information to the computing device 16. The transmitter 12a is then moved to second and third known locations to calculate the locations via triangulation. The computing device 16 then determines the locations of the receivers 14a-d based on the calculated locations of the transmitter 12a. Environmental considerations and signal interference/degradation of the signal, which may be dependent on a given signal frequency, is taken into account. The calibration steps may need to be performed multiple times depending on the frequencies used. Additional calibration steps may need to be performed to account for time-keeping discrepancies between the transmitters 12a-c. The transmitters 12a-c are placed in a single known location. For example, the transmitters 12a-c may be activated at a precise location in a package in which they are received. Because the receivers 14a-d should receive the signals from the transmitters 12a-c at the same time, any difference is accounted for in the calculations of the computing device 16.

As an example of the tracking system 10 in use, and as shown in FIG. 2, a player 100 kicking a soccer ball 104 is wearing several transmitters 12a-c that are located on various body parts of the player 100. An additional transmitter 12d is attached to the soccer ball 104.

Each transmitter 12a-d generates a signal as described above. The receivers 14a-d receive the signals and communicate them to the computing device 16 for processing, analyzing, or storing the data in the signals as described above.

As such, data collected by the tracking system 10 may show that the player 100 has rotated his hips while kicking the ball 104 based upon the detected movement of the transmitters 12b located at his hip and the movement of the transmitter 12a located on his foot. This information can be used to assist the player 100 in improving his skill level and/or correcting his mechanics.

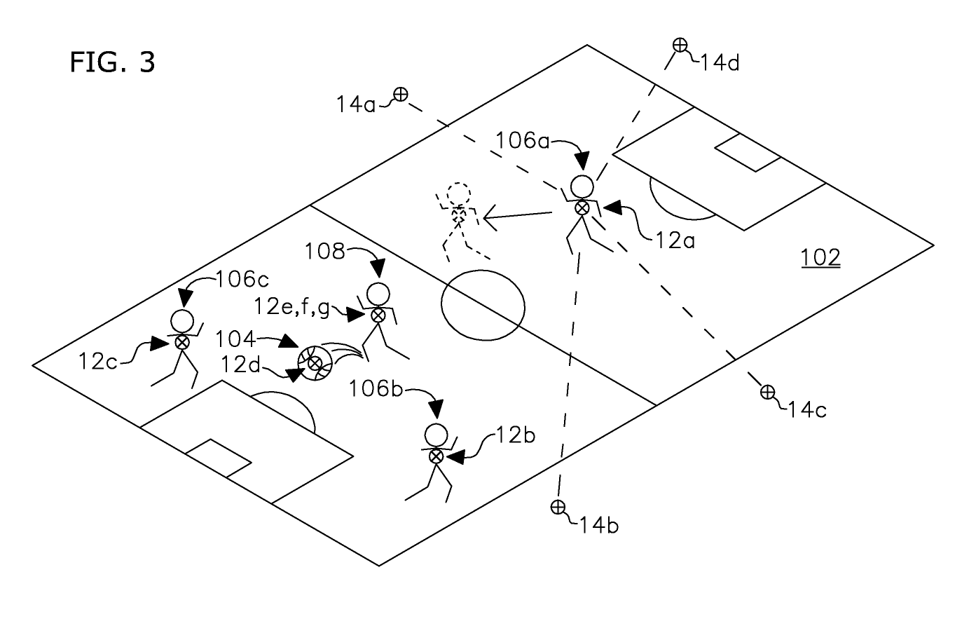

As another example of the tracking system 10 in use, and as shown in FIG. 3, the tracking system 10 simultaneously tracks the individual gross movements of a number of soccer players 106a-c; the fine movements of the leg, ankle, and foot of a striker 108; and the movement of the soccer ball 104 as it travels through a three-dimensional space (area above soccer field 102) during a game. Each player 106a-c has a transmitter 12a-c, respectively, attached to his body or clothing. The soccer ball 104 has a transmitter 12d attached to it. The striker 108 has transmitters 12e-g attached to his upper leg, lower leg, and foot, respectively, to detect minute changes in movement and direction of these body parts as he kicks the soccer ball 104. The transmitters 12a-g simultaneously generate a plurality of signals at the same rate and frequency as described above. The receivers 14a-d receive the signals, identify the transmitters 12a-g, and communicate the tracking data in the signals to the computing device 16 to be analyzed and/or stored as described above.

Although the present invention has been described with reference to the embodiments illustrated in the attached drawing figures, it is noted that equivalents may be employed and substitutions made herein without departing from the scope of the present invention as recited in the claims. Having thus described various embodiments of the present invention, what is claimed as new and desired to be protected by Letters Patent includes the following:

1. A system for remotely tracking the movement and location of an object in a three-dimensional space, the system comprising:
a transmitter configured to be attached to the object for transmitting a signal;
at least three receivers spaced from each other, each receiver configured to receive the signal; and
a computing device for calculating a position of the transmitter based on known positions of the receivers and a time difference between a time that the transmitter transmits the signal and a time that each receiver receives the signal.

2. The system of claim 1, wherein the transmitter is configured to transmit a signal at least every 1/10^{th} of a second.

3. The system of claim 1, wherein a frequency of the signal is at least 433 MHz.

4. The system of claim 1, further comprising at least one additional transmitter configured to transmit an additional signal for tracking an additional object.

5. The system of claim 4, wherein each signal includes a unique identifier for identifying which transmitter generated the signal.

6. The system of claim 4, wherein each transmitter includes a unique identifier for identifying the respective transmitter.

7. The system of claim 6, wherein each unique identifier is an alpha-numerical code.

8. The system of claim 1, wherein the receivers are configured to be calibrated by communicating with the computing system and identifying which transmitter transmits each signal.

9. The system of claim 1, wherein the transmitter includes a switch for activating it.

10. The system of claim 1, wherein the transmitter includes a power source.

11. The system of claim 1, wherein the receiver includes an antenna for sensing the signal.

12. The system of claim 1, wherein the transmitter includes a timer for triggering a signal to be transmitted.

13. The system of claim 1, wherein the signal includes a sequential indicator for indicating when the signal was transmitted.

14. The system of claim 1, wherein the computing device includes a memory for storing data received from the receivers and for storing results of the calculation.

15. A system for remotely tracking the movement and location of an object in a three-dimensional space, the system comprising:
a plurality of transmitters each configured to be attached to an object for transmitting a signal;
at least three receivers spaced from each other, each receiver configured to receive the signals; and
a computing device for calculating a position of each transmitter based on known positions of the receivers and a time difference between a time that the transmitter transmits the respective signal and a time that each receiver receives the respective signal.

16. The system of claim 15, wherein each signal includes a unique identifier for identifying which transmitter generated the signal.

17. The system of claim 15, wherein each transmitter includes a unique identifier for identifying the respective transmitter.

18. The system of claim 15, wherein the receivers are configured to be calibrated by communicating with the computing system and identifying which transmitter transmits each signal.

19. The system of claim 15, wherein each signal includes a sequential indicator for indicating when the signal was transmitted.

20. A system for remotely tracking the movement and location of an object in a three-dimensional space, the system comprising:
a plurality of transmitters each configured to be attached to an object for transmitting a signal at least every 1/10^{th} of a second, each transmitter including a power source, a switch for activating the transmitter, and a timer for triggering the signal transmission, each signal including a unique identifier for identifying which transmitter transmitted the signal;
at least three receivers spaced from each other, each receiver including an antenna for sensing the signals; and
a computing device for calculating a position of each transmitter based on known positions of the receivers and a time difference between a time that the transmitter transmits the respective signal and a time that each receiver receives the respective signal.
